(19) United States
(12) Patent Application Publication
(10) Pub. No.: US 2013/0166093 A1
(43) Pub. Date: Jun. 27, 2013

(54) ELECTRONIC DEVICE AND TEMPERATURE CONTROL METHOD THEREOF

(71) Applicants: Jae Choon Kim, Incheon (KR); Jichul Kim, Yongin-si (KR); Hyunggil Baek, Suwon-si (KR); Eunseok Cho, Suwon-si (KR)

(72) Inventors: Jae Choon Kim, Incheon (KR); Jichul Kim, Yongin-si (KR); Hyunggil Baek, Suwon-si (KR); Eunseok Cho, Suwon-si (KR)

(73) Assignee: Samsung Electronics Co., Ltd., Suwon-si (KR)

(21) Appl. No.: 13/617,262

(22) Filed: Sep. 14, 2012

(30) Foreign Application Priority Data
Dec. 26, 2011 (KR) 10-2011-0142288

(51) Int. Cl. G05D 23/00

(52) U.S. Cl. 700/299

(57) ABSTRACT

An electronic device may be operated in any of a plurality of heat-dissipation modes to accommodate temperature rises, including rapid temperature rises, while allowing an electronic device to continue operating. A parameter such as clock frequency, a supply voltage, current consumption, the number of applications running, or other operating parameter, may be manipulated to control internal heat dissipation and thereby accommodate factors, such as external temperature rises. One operation mode may be a maximum operation mode in which clock(s) operate at their highest frequencies and power is supplied at its highest level. A shut-down operation mode, in which a processor cuts power to electronic components, may be entered when a temperature of interest exceeds a predetermined threshold.

### CROSS-REFERENCE TO RELATED APPLICATIONS

A claim for priority under 35 U.S.C. §119 is made to Korean Patent Application No. 10-2011-0142288 filed Dec. 26, 2011, the entirety of which is incorporated by reference herein.

### BACKGROUND

Exemplary embodiments in accordance with principles of inventive concepts relate to an electronic device, and more particularly, relate to an electronic device including temperature control apparatus and method.

The use of mobile electronic devices, such as smartphones, tablet PCs, digital cameras, MP3 players, and PDA, has become ubiquitous. One reason for the dramatic increase in use of such devices is the rapidly-increasing capability of such devices. Greater memory, faster processors, more elaborate applications, all lead to greater acceptance in the marketplace. However, the increased capabilities of such devices may increase their heat dissipation, which, in turn may negatively-impact their reliability. An apparatus and method that allows an electronic device to accommodate increased operating temperatures, which may, for example, result from heat dissipated by internal components, would therefore be highly desirable.

### SUMMARY

In an exemplary embodiment in accordance with principles of inventive concepts a temperature control method of an electronic device includes detecting whether a temperature of a target point is greater than or equal to a first reference temperature; setting an operating parameter of the electronic device to a first mode of operation when a temperature of the target point is greater than or equal to the first reference temperature; detecting whether a temperature of the target point is greater than or equal to a second reference temperature higher than the first reference temperature; and setting the operating parameter of the electronic device to a second mode of operation when a temperature of the target point is greater than or equal to the second reference temperature, an operating speed of the electronic device at the second mode of operation being lower than an operating speed of the electronic device at the first mode of operation.

Such a method may include setting the operating parameter of the electronic device to an operating mode corresponding to a maximum speed when a temperature of the target point is below a predetermined temperature lower than the first reference temperature.

In an exemplary embodiment in accordance with principles of inventive concepts, the method may include setting the operating parameter of the electronic device to an operating mode corresponding to a maximum speed or the first mode of operation when a temperature of the target point is below the second reference temperature.

The method may also include detecting whether a temperature of the target point is greater than or equal to a third reference temperature higher than the second reference temperature.

In an exemplary embodiment in accordance with principles of inventive concepts, a temperature control method may include setting the operating parameter of the electronic device to the second mode of operation when a temperature of the target point is below the third reference temperature. Additionally, the method may include interrupting a power of the electronic device when a temperature of the target point is greater than or equal to the third reference temperature. In accordance with principles of inventive concepts, the operating parameter may include at least one of a frequency of a driving clock of the electronic device, a level of a power supply voltage, a magnitude of a supplied current, or the number of application programs driven at the same time.

In accordance with principles of inventive concepts, a temperature control method may include a target point spaced apart by a specific interval from a temperature sensor measuring the temperature at the electronic device. The temperature of the target point may be calculated based on a temperature measured by the temperature sensor, heat resistance corresponding to the specific interval, and emitted heat.

In accordance with principles of inventive concepts an electronic device may include a temperature sensor measuring a current temperature; an application processor configured to calculate a temperature of a target point based on the current temperature provided from the temperature sensor, to compare the temperature of the target point with a plurality of reference temperatures, and to set an operating parameter so as to be driven in one of a plurality of modes of operation, according to the comparison.

An electronic device in accordance with principles of inventive concepts may also include an application processor configured to set the operating parameter to a first mode of operation when the temperature of the target point is greater than or equal to a first reference temperature, and to set the operating parameter to a second mode of operation when the temperature of the target point is greater than or equal to a second reference temperature higher than the first reference temperature. The application processor may also be configured to interrupt power when the temperature of the target point is greater than or equal to a third reference temperature higher than the second reference temperature.

An electronic device in accordance with principles of inventive concepts may also include a DRAM loading at least one application program driven by the application processor, the application processor and the DRAM being configured in a package-on-package (POP) manner. Additionally, the operating parameter may include at least one of a frequency of a driving clock, a level of a power supply voltage, a magnitude of a supplied current, or the number of application programs loaded onto the DRAM.

The electronic device may include a case surrounding the application processor and the DRAM, the target point corresponding to a surface of the case.

In accordance with principles of inventive concepts, an electronic device may include a temperature sensor; and a processor configured to operate the electronic device in one of a plurality of heat-dissipation modes according to the output of the temperature sensor. The heat-dissipation modes may be characterized by the processor controlling at least one of: a clock frequency, a level of a power supply voltage, the magnitude of a current, or the number of application programs concurrently operating.

In accordance with principles of inventive concepts, the processor may be configured to compute a temperature using the output of the temperature sensor and use the computed temperature to determine in which of the plurality of heat dissipation modes to operate. The electronic device may be a mobile electronic device, such as a smart phone, a tablet computer, an MP3 player, or a personal digital assistant, for example.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a cross-sectional view of an exemplary embodiment of a semiconductor device in accordance with principles of inventive concepts.

FIG. 2 is a block diagram schematically illustrating an application processor in FIG. 1.

FIG. 3 is a flowchart describing a temperature managing method in accordance with principles of inventive concepts.

FIG. 4 is a mode diagram describing an exemplary embodiment in accordance with principles of inventive concepts.

FIG. 5 is a flowchart describing a clock frequency control method in accordance with principles of inventive concepts.

FIG. 6 is a diagram describing a variation in frequency due to a variation in temperature when a temperature control method in accordance with principles of inventive concepts is used.

FIG. 7 is a diagram schematically illustrating a cross section of an electronic device and a heat circuit modeling according to an exemplary embodiment in accordance with principles of inventive concepts.

FIG. 8 is a block diagram schematically illustrating a memory system in accordance with principles of inventive concepts.

FIG. 9 is a block diagram schematically illustrating a computer system performing a temperature control operation in accordance with principles of inventive concepts.

### DETAILED DESCRIPTION

Exemplary embodiments in accordance with principles of inventive concepts will now be described more fully with reference to the accompanying drawings, in which exemplary embodiments are shown. Exemplary embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of exemplary embodiments to those of ordinary skill in the art. In the drawings, the thicknesses of layers and regions may be exaggerated for clarity. Like reference numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “bottom,” “below,” “lower,” or “beneath” other elements or features would then be oriented “atop,” or “above,” the other elements or features. Thus, the exemplary terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Exemplary embodiments in accordance with principles of inventive concepts are described herein with reference to cross-sectional illustrations that are schematic illustrations of idealized embodiments (and intermediate structures) of exemplary embodiments. As such, variations from the shapes of the illustrations as a result, for example, of manufacturing techniques and/or tolerances, are to be expected. Thus, exemplary embodiments in accordance with principles of inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Although exemplary embodiments related to mobile electronic devices in accordance with principles of inventive concepts will be described herein, inventive concepts are not limited thereto.

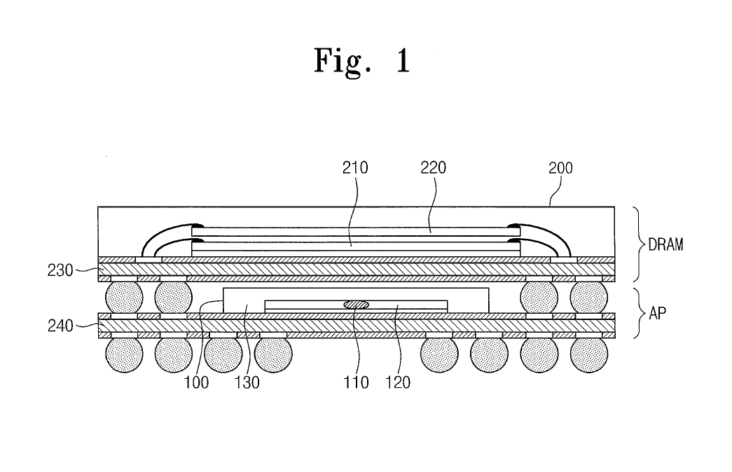

FIG. 1 is a cross-sectional view of an exemplary embodiment of a semiconductor device in accordance with principles of inventive concepts, which may include an application processor 100 and a DRAM 200. The application processor 100 and the DRAM 200 of the semiconductor device may be implemented using Package-On-Package (POP) packaging technology, for example.

The application processor 100 may include a temperature sensor 110 and an application processor (AP) chip 120 that are placed on a printed circuit board (PCB) substrate 240. The AP chip 120 may be placed within a molding layer 130 forming the outside of a package. The AP chip 120 may execute operations for driving an electronic device according to an operating system and application program(s), for example. The temperature sensor 110 may be included within the AP chip 120 or mounted outside the AP chip 120. A temperature signal measured by the temperature sensor 110 may be provided to the AP chip 120. The AP chip 120 may calculate a temperature of an internal or external specific point of the application processor 100 based on the temperature signal from the temperature sensor 110, for example. In exemplary embodiments in accordance with principles of inventive concepts, the AP chip 120 may adjust an operating parameter of the device in order to accommodate the calculated temperature.

The DRAM 200 may be provided as a working memory of the AP chip 120. The DRAM 200 may be stacked over the PCB substrate 230 by a plurality of layers. For example, the DRAM 200 may be formed of a multi-chip package in which a first chip 210 and a second chip 220 are stacked. Various application programs driven by the AP chip 120 may be loaded into the DRAM 200 for operation. A large volume of working memory may be required to drive many application programs for multi-tasking and, as a result, the DRAM 200 may be formed of a multi-chip package in which a plurality of chips are stacked.

The POP structure of the application processor 100 and the DRAM 200 was above described. For a POP structured semiconductor package, a critical issue may be to manage a temperature for the performance and reliability. In particular, in devices such as a smartphone, a tablet PC, and the like, it is necessary to manage an internal temperature of the application processor 100 and a temperature at an external specific point of the application processor 100. For example, compared with an internal temperature of the application processor 100, the performance, the reliability, and the convenience of user may be further affected by an external temperature of the application processor 100 under an external high-temperature circumstance. Increases in external temperature may lead to increases in internal temperature. Additionally, elements of a device may reach critical temperatures due, in part, to external factors. Such high-temperature effects may be ameliorated by controlling internal heat dissipation in accordance with principles of inventive concepts. The application processor 100 in accordance with principles of inventive concepts may perform a temperature control operation to reduce the reduction in reliability and performance that might otherwise take place due to high external temperatures.

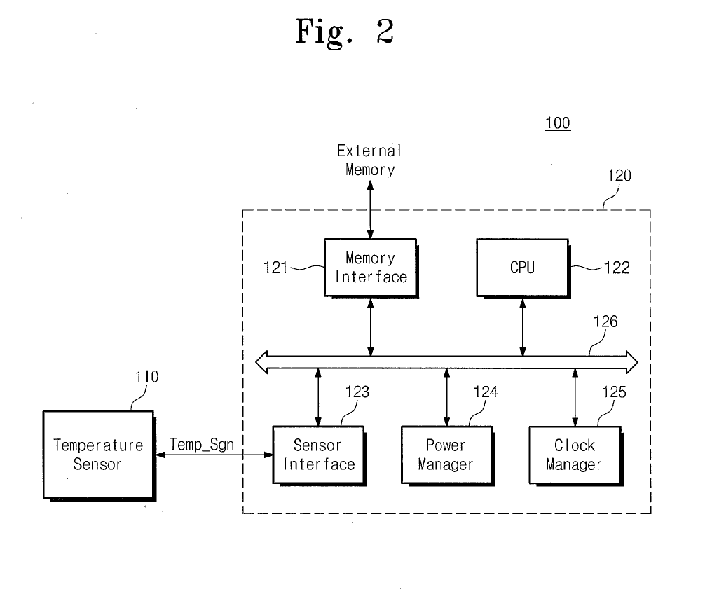

The block diagram of FIG. 2 illustrates functional blocks of an exemplary embodiment of an application processor 100, which may include a temperature sensor 110 and AP chip 120, in accordance with principles of inventive concepts.

The temperature sensor 110 may sense an internal temperature of the application processor 100 and provide an output a temperature signal Temp_Sgn. In exemplary embodiments in accordance with principles of inventive concepts, the temperature sensor 110 may be a thermoelectromotive force (or, thermoelement) sensor using electromotive force varying according to a temperature, or a thermal conductivity sensor sensing a magnitude of a resistance varying according to a temperature, for example. However, other temperature-measuring methods are contemplated within the scope of inventive concepts.

In exemplary embodiments in accordance with principles of inventive concepts, AP chip 120 may employ the temperature signal Temp_Sgn provided by the temperature sensor 110 to perform a multi-level temperature control operation according to a plurality of temperatures. The AP chip 120 may include a memory interface 121, a CPU 122, a sensor interface 123, a power manager 124, and a clock manager 125. The AP chip 120 may also include: a cipher engine, a ROM, an SRAM, an image processing block, or a user interface, for example.

The memory interface 121 may be configured to exchange data between the AP chip 120 and a volatile memory such as a DRAM 200 (refer to FIG. 1), for example, or between the AP chip 120 and a nonvolatile memory such as a NAND flash memory. The memory interface 121 may read data stored in memory devices under control of the CPU 122. The memory interface 121 may perform a Direct Memory Access (DMA) function associated with memory devices, for example.

The CPU 122, which may be a multi-core CPU, for example, may perform various operations according to firmware. For example, the CPU 122 may drive an operating system or an application program that is resident in the DRAM 200, which may act as a working memory. In particular, the CPU 122 may control a temperature based on current temperature information provided from the sensor interface 123. To control a temperature, such as an operating temperature of the device 200, the CPU 122 may be provided with firmware for executing a multi-level temperature control operation. For example, if the AP chip 120 determines from the signal Temp_Sgn that a predetermined temperature has been reached, it, or, more specifically, the CPU 122 may adjust the heat dissipation of the electronic device that includes the AP chip 120 by reducing the clock frequency (using clock manager 125, for example), or reducing the number of application programs that are running to reduce the temperature, for example. If the device temperature continues to rise despite these actions, the CPU 122 may further reduce the frequency of a driving clock, reduce a driving voltage, or reduce the number of application programs running so that only essential functions are performed. The “driving clock” whose frequency is adjusted may be a clock that drives the application processor 100, or another clock that drives another component, or a master clock that drives an entire electronic device, such as a smart phone, including all components of the electronic device, for example.

In exemplary embodiments in accordance with principles of inventive concepts the sensor interface 123 may convert the temperature signal Temp_Sgn from an analog form to digital data compatible with the CPU 122. One application processor 100 may provide a variety of sensor signals. In accordance with principles of inventive concepts, a sensor signal may include an acceleration signal provided from an acceleration sensor measured in a three dimension, a rotation signal provided from a rotary motion sensor, an illumination signal provided from an illumination sensor, a pressure signal provided from a pressure sensor, a temperature signal, or other sensor signals, for example. The sensor interface 123 may convert such sensor signals to data and the data may be provided to the CPU 122 to be managed by a proper application program.

In exemplary embodiments in accordance with principles of inventive concepts, the power manager 124 may manage internal powers of the electronic device and the application processor 100 under the control of the CPU 122. The power manager 124 may control a voltage or a current under the control of the CPU 122 to lower a temperature of a specific point of the application processor 100, a package or an electronic device that includes the application processor 100.

The clock manager 125 may manage clocks used to drive both the electronic device and the application processor 100 under the control of the CPU 122. The clock manager 125 may control a clock frequency under the control of the CPU 122 to lower a temperature of a specific point of the application processor 100, a package or the electronic device. The clock manager 125 may reduce a clock frequency to reduce the heat dissipation, and, thereby, reduce or maintain the temperature of the application processor 100, for example.

In accordance with principles of inventive concepts multiple modes of operation may be employed to accommodate temperature rises, including rapid temperature rises, while allowing an electronic device to continue operating. An application processor 100, for example, may control a clock frequency, a supply voltage, or other operating parameter, to control internal heat dissipation and thereby accommodate factors, such as external temperature rises, for example. One operation mode may be a maximum operation mode in which clock(s) operate at their highest frequencies and power is supplied at its highest level. Additional modes may operate with reduced power dissipation (for example, with lower clock frequencies or lower-level power supplied to electronic devices), depending upon a range in which a temperature of interest falls. The temperature of interest may be directly measured at a location within an electronic device, or may be derived from a direct measurement, using thermal modeling, for example. A shut-down operation mode, in which a processor cuts power to electronic components, may be entered when a temperature of interest exceeds a predetermined threshold.

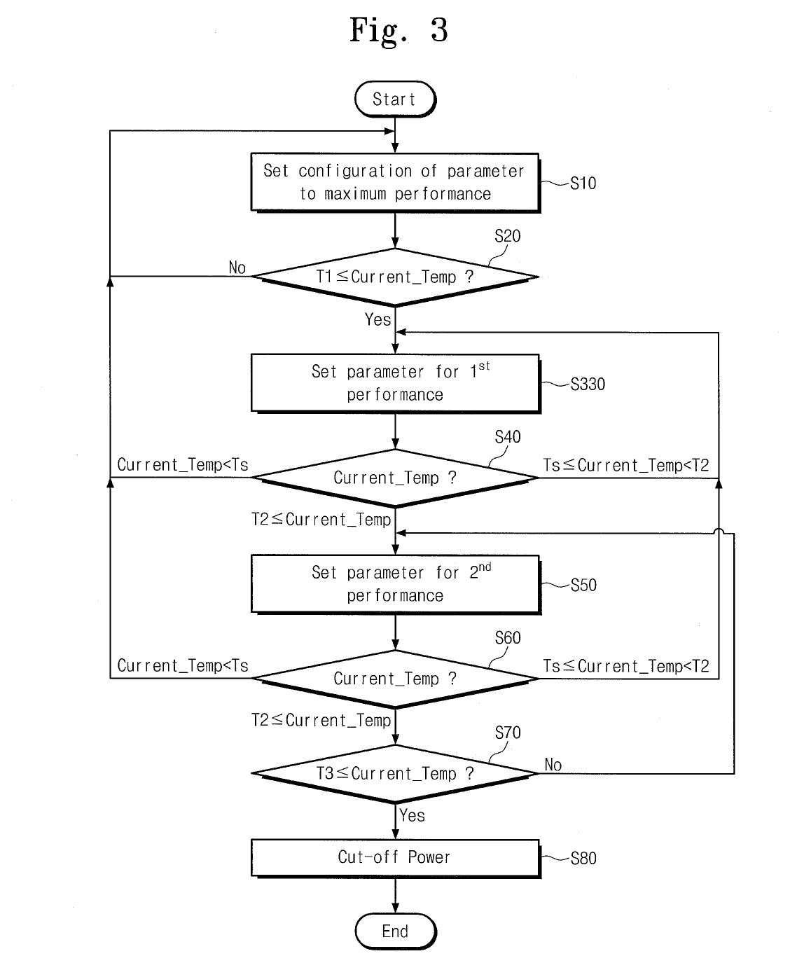

An exemplary embodiment of a temperature-control method in accordance with principles of inventive concepts will be described in the discussion related to the flowchart of FIG. 3. Such a temperature-control method may be employed by an application processor 100 and, in an exemplary embodiment in accordance with principles of inventive concepts, may commence whenever an electronic device (e.g., smart phone) including application processor 100 is “powered up” (that is, when the device is turned on).

In operation S10, the CPU 122 may set one or more operating parameters such that an application processor 100 is driven in a maximum performance mode of operation. The operating parameter may include a clock frequency, a power supply voltage, a magnitude of a current, or the number of application programs being driven at the same time, for example. That is, in an exemplary embodiment in accordance with principles of inventive concepts, the CPU 122 may initially set one or more operating parameters at a maximum value, corresponding to high speed operation.

In operation S20, the CPU 122 may determine whether a temperature, Current_Temp, is greater than or equal to a first reference temperature T1. In an exemplary embodiment in accordance with principles of inventive concepts, temperature T1 may be selected from within a predetermined, preferred, operating temperature range, for example. If the current temperature Current_Temp is not greater than the first reference temperature T1, the method proceeds to operation S10. If the current temperature Current_Temp is greater than or equal to the first reference temperature T1, the method proceeds to operation S30. As described in greater detail below, the temperature Current_Temp may be a temperature associated with one or more temperature sensors or other locations within a device that includes application processor 100, including temperatures determined by thermal modeling, for example.

In operation S30, the CPU 122 may set an operating parameter so that application processor 100 is driven in a first performance mode of operation, which may be associated with slower operation than a maximum performance mode of operation, for example. To set the application processor to the first performance mode of operation, a clock speed, drive voltage or current consumption may be reduced, for example.

In operation S40, the CPU 122 may again determine the current temperature Current_Temp. In accordance with principles of inventive concepts, if the current temperature Current_Temp is lower than a stable temperature Ts (Ts<T1), the method returns to operation S10 to be restored to the maximum performance mode of operation. If the current temperature Current_Temp is greater than or equal to the stable temperature Ts and less than or equal to a second reference temperature T2 (T1<T2), the method returns to operation S30 to maintain the first performance mode of operation. If the current temperature Current_Temp is greater than or equal to the second reference temperature T2, the method proceeds to operation S50.

In operation S50, the CPU 122 may set an operating parameter such that the application processor 100 is driven in a second performance mode of operation, which may consume less power than the first performance mode of operation. A processing speed of the second performance mode of operation may be slower than that of the first performance mode of operation. In a reduced-power mode of operation such as the second performance mode of operation a clock may be reduced beyond that of the first performance mode of operation by reducing a driving voltage or the magnitude of current being consumed, or, the CPU 122 may reduce a clock frequency to be set to the second performance mode of operation. A clock frequency of the second performance mode of operation may be lower than that of the first performance mode of operation.

In operation S60, the CPU 122 may detect the current temperature Current_Temp. If the current temperature Current_Temp is below the stable temperature Ts, the method returns to operation S10 where the maximum performance mode of operation is restored. If the current temperature Current_Temp is greater than or equal to the stable temperature Ts and less than or equal to the second reference temperature T2, the method returns to operation S30 to maintain the first performance mode of operation. If the current temperature Current_Temp is greater than or equal to the second reference temperature T2, the method proceeds to operation S70.

In operation S70, the CPU 122 may determine whether the current temperature Current_Temp is greater than or equal to a third reference temperature T3. If the current temperature Current_Temp is not greater than the third reference temperature T3, the method proceeds to operation S50 to maintain the second performance mode of operation. Thus, in the case that the current temperature Current_Temp is higher than the second reference temperature T2 and lower than the third reference temperature T3, a loop of operations S50, S60, and S70 may be iterated to maintain the second performance mode of operation. On the other hand, if the current temperature Current_Temp is greater than or equal to the third reference temperature T3, the method proceeds to operation S80, where the CPU 122 interrupts power to prevent the application processor 100 or other devices from being damaged.

With the exemplary temperature management method in accordance with principles of inventive concepts just described, the application processor 100 may stepwise set a mode of operation to a maximum performance mode of operation, a first performance mode of operation, and a second performance mode of operation. In this manner, although a temperature rise, essential functions may be provided according to management of the performance mode. In accordance with principles of inventive concepts, the reliability of the application processor 100 or the electronic device including the same may be improved by managing a multi-level performance mode according to a variation in temperature.

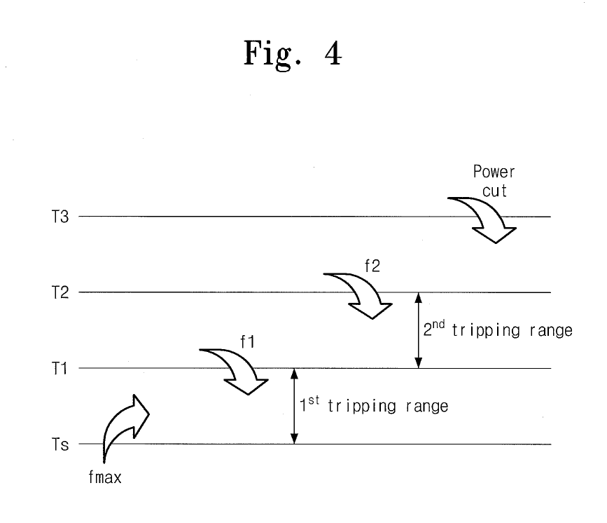

FIG. 4 is a level-diagram illustrating an exemplary embodiment of an electronic device temperature control method in accordance with principles of inventive concepts. In the exemplary embodiment a clock frequency may be adjusted to drive the device into any of the performance modes associated with clock frequencies fₘₐₓ, f₁, f₂, and “power cut.” In this exemplary embodiment, when an electronic device or an application processor 100 is booted up, the frequency of the driving clock CLK may be set to the maximum frequency fₘₐₓ. Operation at this frequency may increase the temperature of the application processor 100. A temperature of the application processor 100 or a temperature of a specific point within an electronic device that includes the application processor 100 may rise over a stable temperature Ts. If a current temperature exceeds a first reference temperature T1 (which may indicate a rise in temperature), the application processor 100 may set a clock CLK to a first frequency f₁, lower than the maximum frequency fₘₐₓ. As the application processor 100 or electronic device operates using the first frequency f1, the temperature of the application processor 100 or other temperature-sensing location of a device that includes the application processor, or point, may be converged between the stable temperature Ts and the first reference temperature T1. If the temperature does not rise sharply, the temperature of the application processor 100 may be maintained between the stable temperature Ts and the first reference temperature T1 for some time. The stable temperature Ts and the first reference temperature T1 may delineate a first tripping range, for example.

The temperature of a specific point, or location, of interest, such as the application processor 100, DRAM 200, or other location within a device, such as a smart phone, that includes application processor 100 can rise sharply due to external heat sources, in addition to internally-generated heat. That is, the temperature of the application processor 100 or the target point of the electronic device may exceed a second reference temperature T2 (T2>T1). As previously described, in an exemplary embodiment in accordance with principles of inventive concepts, the application processor 100 may set the frequency of a clock CLK to a second frequency f2 that is lower than the first frequency f1 in order to reduce heat dissipation when the application processor determines that a temperature of interest (e.g., temperature of the application processor 100, of the DRAM 200, or of another location in the device) exceeds temperature T2.

As the application processor 100 or an electronic device operates using a driving clock having the first frequency f1, a temperature of the application processor 100 or the specific target point may settle between the first reference temperature T1 and the second reference temperature T2. The first reference temperature T1 and the second reference temperature T2 may define a second tripping range. If a temperature of a location or point of interest does not rise too sharply, the temperature (for example, of the application processor 100) may be maintained between the first reference temperature T1 and the second reference temperature T2, that is, within the second tripping range. In this manner, the application processor 100 or the electronic device including the application processor 100 may operate in a minimum performance mode of operation to avoid circuit or data damage.

If a temperature of interest (that is, of the application processor 100 or a specific target point of the electronic device including the application processor 100) exceeds a third reference temperature T3, the application processor 100 may interrupt a power to other devices and/or shut itself down to avoid damage.

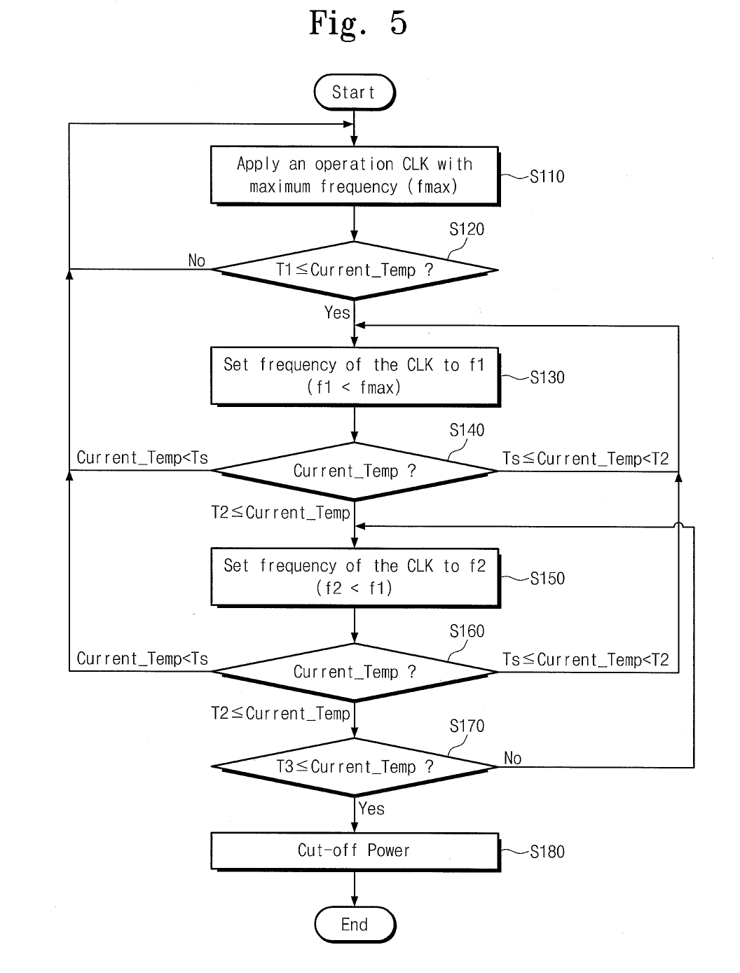

An exemplary embodiment of a clock-frequency control method in accordance with principles of inventive concepts will be described in the discussion related to the flowchart of FIG. 5. In FIG. 5, a multi-level temperature control operation may be executed by controlling a frequency via a CPU 122 (refer to FIG. 2). A temperature/frequency control process in accordance with principles of inventive concepts may commence whenever power is applied to an application processor 100 or an electronic device including the application processor 100.

In operation S110, the CPU 122 may set the frequency of a driving clock (for example, the application processor's clock) to a maximum frequency fmax to thereby drive the application processor 100 or an electronic device including the application processor 100 in a maximum performance mode of operation.

In operation S120, the CPU 122 may determine whether a current temperature Current_Temp is greater than or equal to a first reference temperature T1. If the current temperature Current_Temp is less than or equal to the first reference temperature T1, the method returns to operation S110 where the clock frequency is maintained at fmax. On the other had, if the current temperature Current_Temp is greater than or equal to the first reference temperature T1, the method proceeds to operation S130.

In operation S130, the CPU 122 may set a clock frequency, such as the clock of the application processor 100 or the electronic device including the application processor 100 to a first frequency f1 that is lower than the maximum frequency fmax. In this manner, heat generated by the application processor 100 or other electronic component included in an electronic device, such as a smart phone, may be reduced.

In operation S140, the CPU 122 may determine the current temperature Current_Temp and, if the current temperature Current_Temp is lower than stable temperature Ts (Ts<T1), the method returns to operation S110. If the current temperature Current_Temp is greater than or equal to the stable temperature Ts and below a second reference temperature T2 (T1<T2), the method proceeds to operation S130. If the current temperature Current_Temp is greater than or equal to the second reference temperature T2, the method proceeds to operation S150.

In operation S150, a driving clock of the application processor 100 or the electronic device including the application processor 100 may be set to a second frequency f2 that is lower than the first frequency f1. In this way, heat generated by the application processor 100 or the electronic device including the application processor 100 due to consumption of a dynamic current may be reduced from that associated with the driving clock having the first frequency f1.

In operation S160, the CPU 122 may determine the current temperature Current_Temp. If the current temperature Current_Temp is below the stable temperature Ts, the method proceeds to operation S110, where the application processor 100 or electronic device including the application processor 100 is driven by the maximum frequency fmax. If the current temperature Current_Temp is greater than or equal to the stable temperature Ts and less than the second reference temperature T2, the method proceeds to operation S130 where the driving clock of the application processor 100 or the electronic device including the application processor 100 is set to the first frequency f1. If the current temperature Current_Temp is greater than or equal to the second reference temperature T2, the method proceeds to operation S170.

In operation S170, the CPU 122 may determine whether the current temperature Current_Temp is greater than or equal to a third reference temperature T3. If the current temperature Current_Temp is less than the third reference temperature T3, the method proceeds to operation S150, where the application processor 100 or the electronic device including the application processor 100 is driven by the driving clock having the second frequency f2. Thus, in the case that the current temperature Current_Temp is greater than or equal to the second reference temperature T2 and lower than the third reference temperature T3, a loop of operations S150, S160, and S170 may be iterated such that the application processor 100 or the electronic device including the application processor 100 is driven by the driving clock having the second frequency f2. On the other hand, in a case where the current temperature Current_Temp is greater than or equal to the third reference temperature T3, the method proceeds to operation S180, where the CPU 122 interrupts power to prevent damage to the application processor 100 and other devices.

With the temperature managing method in accordance with principles of inventive concepts, the application processor 100 or the electronic device including the application processor 100 may stepwise set the frequency of a driving clock to the maximum frequency fmax, the first frequency f1, or a second frequency f2 according to temperature. Thus, although a temperature rises, essential functions may be provided according to management of a performance mode. The reliability of the application processor 100 and electronic device including the application processor 100 may be maintained by operating in different performance modes according to the temperature of the application processor or other location within the electronic device.

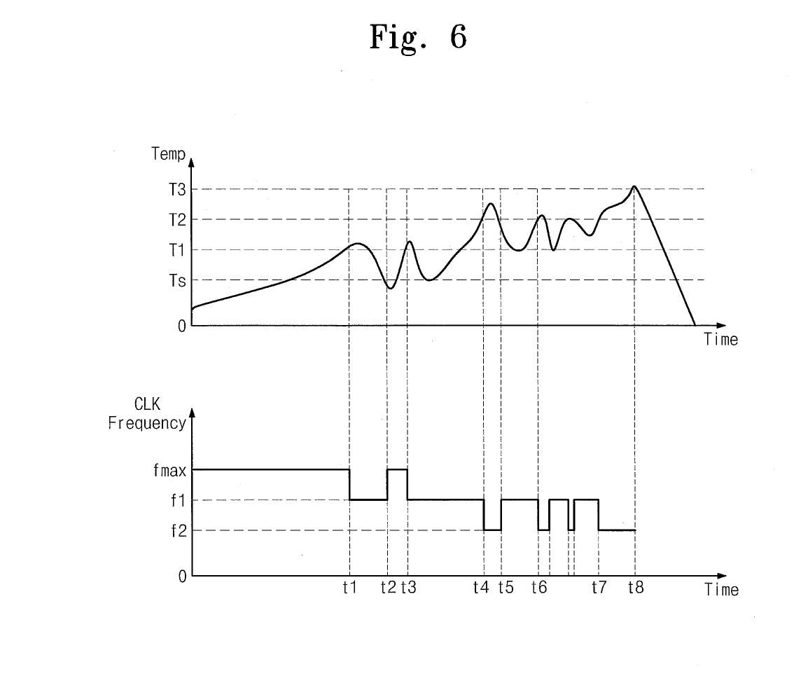

FIG. 6 is a time-diagram illustrating a variation in frequency due to a variation in temperature when a temperature control method in accordance with principles of inventive concepts, such as the method described in the discussion related to FIG. 5 is used. In this exemplary embodiment an electronic device may be controlled to operate at any of three clock frequencies, in order to accommodate temperature variations.

If an application processor 100 or an electronic device including the application processor 100 is powered and a driving clock having a maximum frequency fmax is provided, a temperature of the application processor 100 or the electronic device including the application processor 100 may rise. The rise of temperature is illustrated by a temperature curve until time t1, at which point, a temperature of the application processor 100 or a specific point of the electronic device including the application processor 100 exceeds a first reference temperature T1. In response, the frequency of the driving clock may be adjusted to a first frequency f1 that is lower than the maximum frequency fmax. As a frequency of the driving clock is lowered, a temperature of the application processor 100 or the electronic device including the application processor 100 may be lowered. This process is illustrated by a temperature curve between times t1 and t2.

A temperature of the application processor 100 or a specific point of the electronic device including the application processor 100 can be lowered below a stable temperature Ts at t2 according to providing of the driving clock having the first frequency f1. Reducing the temperature “below a stable temperature,” does not imply that the temperature of the device is reduced to a level that is somehow unstable, or unsafe. The term “stable temperature” is used herein to refer to a temperature that is at the upper threshold of a range of temperatures in which it is acceptable to operate the application processor 100 and/or associated electronic devices at a maximum frequency. As previously indicated, that temperature may be predetermined from a range of safe operating temperatures, for example. When the temperature has been reduced to the stable temperature, a frequency of the driving clock may be set to the maximum frequency fmax. This process may be referred to as a first tripping range.

If the external temperature rises sharply, the temperature of the application processor 100 or the electronic device including the application processor 100 may also rise sharply over a second reference temperature T2 particularly when internal heat generation contributes to device temperature. This case is illustrated at time t4. If a temperature of the application processor 100 or the electronic device including the application processor 100 exceeds a second reference temperature T2, the frequency of the driving clock may be set to a second frequency f2. As a temperature is controlled according to the above-described manner, a temperature of the application processor 100 or the electronic device including the application processor 100 may be reduced to a range between the first reference temperature T1 and the second reference temperature T2. This may be referred to as a second tripping range.

A temperature of the application processor 100 or the electronic device including the application processor 100 can exceed a third reference temperature T3. In this case, power may be interrupted to protect the application processor 100 or the electronic device, as illustrated at time t8.

In accordance with principles of inventive concepts, it is possible to stepwise cope with a sharp rise of temperature, which may be due to an external circumstance. Thus, it is possible prevent damage of the application processor 100 or the electronic device including the application processor 100 and to protect internal circuits and data.

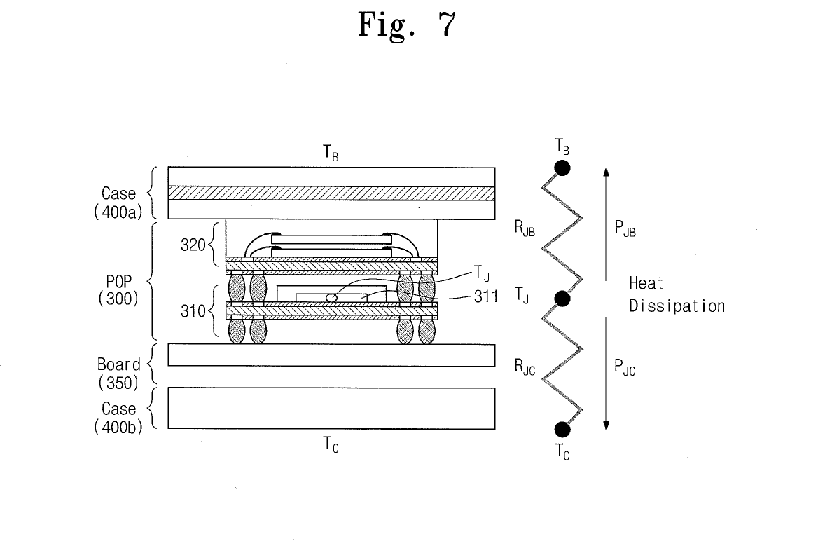

FIG. 7 is a diagram schematically illustrating a cross section of an electronic device and associated heat circuit model according to an exemplary embodiment in accordance with principles of inventive concepts. Referring to FIG. 7, an electronic device in accordance with principles of inventive concepts may include a POP 300 including an application processor 311, a PCB board 350 on which the POP 300 is mounted, an upper case 400a, and a lower case 400b.

The application processor 311 including a temperature sensor may be provided at a lower layer of the POP 300, and a DRAM 320 provides as a working memory may be provided at an upper layer of the POP 300. The temperature sensor of the application processor 311 may directly measure an internal temperature TJ of the application processor 311. A temperature TB of a case surface may be calculated via a heat circuit modeling using the measured internal temperature TJ. Correlation between the surface temperature TB of the upper case 400a and the internal temperature TJ of the application processor 311 measured by the temperature sensor may be expressed by the following equation 1.

T_{J}=T_{B}+R_{JB}SP_{JB} (1)

In the equation 1, R_{JB} may indicate heat resistance between the temperature sensor and a surface of the upper case, and P_{JB} may indicate heat emitted from a surface of the upper case.

Correlation between a surface temperature T_{C} of the lower case 400b and the internal temperature T_{J} of the application processor 311 measured by the temperature sensor may be expressed by the following equation 2.

T_{J}=T_{C}+R_{JC}SP_{JC} (2)

In the equation 2, R_{JC} may indicate heat resistance between the temperature sensor and a surface of the lower case, and P_{JC} may indicate heat emitted from a surface of the lower case.

In accordance with principles of inventive concepts, a temperature of interest may be determined, or measured, with respect to not only a point where the temperature sensor is placed but also points capable of being modeled by a heat transmission phenomenon, using, for example, equations 1 and 2. This may mean that reference temperatures associated with many points of the electronic device are capable of being set. For example, in case that the upper case 400a corresponds to a glass plate placed at a top of a display of a smartphone, it is possible to measure a temperature of a display surface. A surface temperature T_{C} of the lower case 400b may also be determined, or measured, using a heat transmission modeling. Reference temperatures Ts, T1, T2, and T3 for comparing a measured temperature may be set according to the following:

T_{S}DT_{B}+R_{JB}SP_{JB} or T_{C}+R_{JC}SP_{JC} (1)

T₁ET_{B}+R_{JB}SP_{JB} or T_{C}+R_{JC}SP_{JC} (2)

T₂DT_{JMAX} (3)

T₃ET_{JMAX} (4)

Herein, T_{JMAX} may indicate an allowable maximum temperature of an application processor.

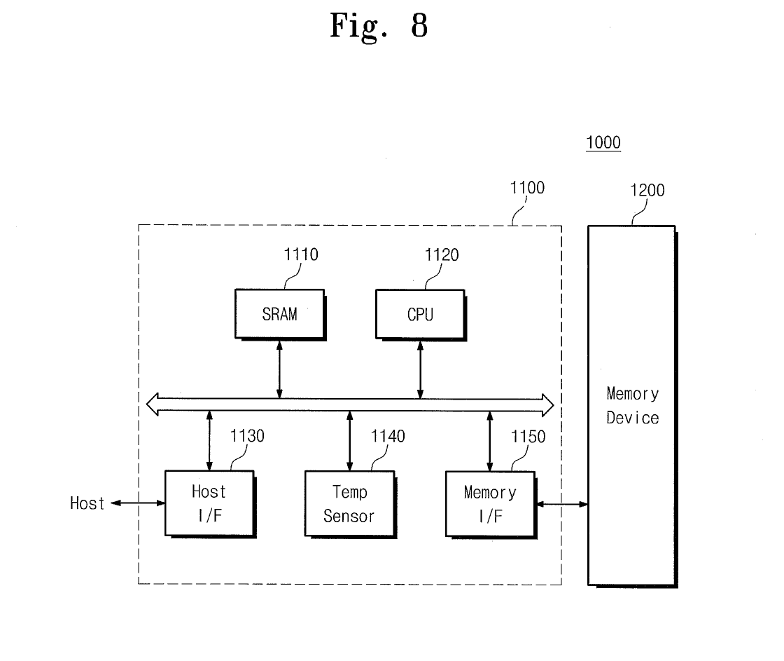

FIG. 8 is a block diagram schematically illustrating a memory system according to an exemplary embodiment in accordance with principles of inventive concepts. Referring to FIG. 8, a memory system 1000 may include a memory device 1200 and a memory controller 1100.

The memory controller 1100 may be configured to control the memory device 1200. The memory device 1200 and the memory controller 1100 may form a Solid State Drive (SSD). An SRAM 1110 may be used as a working memory of a CPU 1120. A host interface 1130 may include the data exchange protocol of a host connected with the memory system 1000. A temperature sensor 1140 may measure a temperature of a location within the memory system 1000. A memory interface 1150 may interface with the memory device 1200 of the inventive concept. The CPU 1120 may perform an overall control operation associated with data exchange of the memory controller 1100. The CPU 1120 may perform a multi-level temperature control operation in accordance with principles of inventive concepts according to temperature information provided by the temperature sensor 1140. Although a temperature may rise sharply due to external factors, the CPU 1120 may detect and manage the temperature of a location within the memory system 1000, and, thereby, the entire system, in accordance with principles of inventive concepts, as described in the discussion of exemplary embodiments, for example, in FIG. 3 or 5 for lowering temperature stepwise.

Although not shown in FIG. 8, the memory system 1000 may further include a ROM that stores code data for interfacing with a host.

The memory controller 1100 may communicate with an external device (e.g., a host) using one of various interface protocols such as USB, MMC, PCI-E, SAS, SATA, PATA, SCSI, ESDI, and IDE.

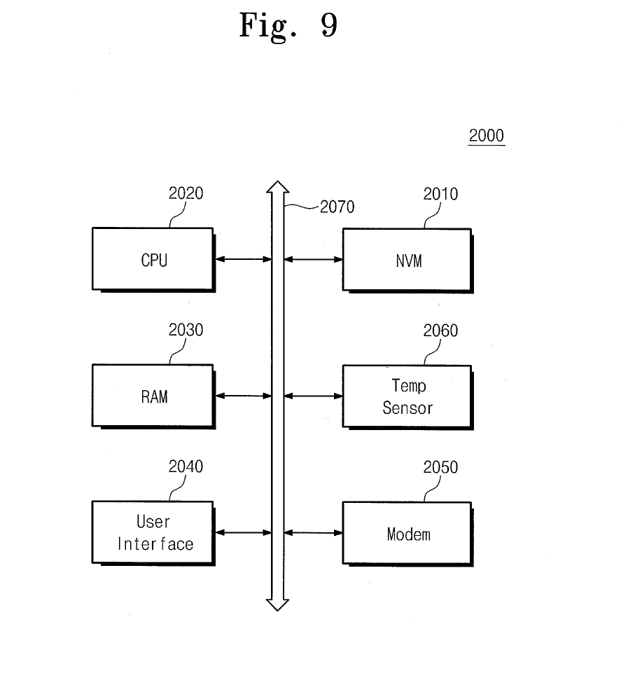

FIG. 9 is a block diagram schematically illustrating a computer system performing a temperature control operation according to an exemplary embodiment in accordance with principles of inventive concepts. Referring to FIG. 9, a computer system 2000 may include a nonvolatile memory device 2010, a CPU 2020, and a RAM 2030 that are electrically connected to a system bus 2070. The computer system 2000 may further comprise a user interface 2040, a modem 2050 such as a baseband chipset, and a temperature sensor 2060. Although the temperature sensor 2060 may be illustrated as an element of the computer system 2000, it may be included within the CPU 2020, for example.

In exemplary embodiments in which the computer system 2000 is a mobile device, it may further include a battery powering an operating voltage of the computer system 2000. Although not shown in FIG. 9, the computer system 2000 may further include an application chipset, a camera image processor (CIS), a mobile DRAM, and the like.

Herein, the CPU 2020 may perform a multi-level temperature control operation in accordance with principles of inventive concepts according to temperature information provided from the temperature sensor 2020. Although a temperature rises sharply due to external factors, the CPU 2020 may detect and manage a temperature of a location associated with sensor 2020, or other location derived from thermal, or heat circuit, models, as previously described, and, thereby the manage the temperature of the mobile device according to a temperature managing method in accordance with principles of inventive concepts, such as illustrated by exemplary embodiments of FIG. 3 or 5 for lowering heat dissipation stepwise.

A memory device or a memory controller in accordance with principles of inventive concepts may be packed by various types of packages such as PoP (Package on Package), BGAs (Ball grid arrays), CSPs (Chip scale packages), PLCC (Plastic Leaded Chip Carrier), PDIP (Plastic Dual In-Line Package), Die in Waffle Pack, Die in Wafer Form, COB (Chip On Board), CERDIP (Ceramic Dual In-Line Package), MQFP (Plastic Metric Quad Flat Pack), TQFP (Thin Quad Flatpack), SOIC (Small Outline Integrated Circuit), SSOP (Shrink Small Outline Package), TSOP (Thin Small Outline), SIP (System In Package), MCP (Multi Chip Package), WFP (Wafer-level Fabricated Package), or WSP (Wafer-Level Processed Stack Package), for example.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

1. A temperature control method of an electronic device comprising:
detecting whether a temperature of a target point is greater than or equal to a first reference temperature;
setting an operating parameter of the electronic device to a first mode of operation when a temperature of the target point is greater than or equal to the first reference temperature;
detecting whether a temperature of the target point is greater than or equal to a second reference temperature higher than the first reference temperature; and
setting the operating parameter of the electronic device to a second mode of operation when a temperature of the target point is greater than or equal to the second reference temperature, an operating speed of the electronic device at the second mode of operation being lower than an operating speed of the electronic device at the first mode of operation.

2. The temperature control method of claim 1, further comprising:
setting the operating parameter of the electronic device to an operating mode corresponding to a maximum speed when a temperature of the target point is below a predetermined temperature lower than the first reference temperature.

3. The temperature control method of claim 1, further comprising:
setting the operating parameter of the electronic device to an operating mode corresponding to a maximum speed or the first mode of operation when a temperature of the target point is below the second reference temperature.

4. The temperature control method of claim 1, further comprising:
detecting whether a temperature of the target point is greater than or equal to a third reference temperature higher than the second reference temperature.

5. The temperature control method of claim 4, further comprising:
setting the operating parameter of the electronic device to the second mode of operation when a temperature of the target point is below the third reference temperature.

6. The temperature control method of claim 4, further comprising:
interrupting a power of the electronic device when a temperature of the target point is greater than or equal to the third reference temperature.

7. The temperature control method of claim 1, wherein the operating parameter includes at least one of a frequency of a driving clock of the electronic device, a level of a power supply voltage, a magnitude of a supplied current, or the number of application programs driven at the same time.

8. The temperature control method of claim 1, wherein the target point is spaced apart by a specific interval from a temperature sensor measuring the temperature at the electronic device.

9. The temperature control method of claim 8, further comprising:
calculating a temperature of the target point based on a temperature measured by the temperature sensor, heat resistance corresponding to the specific interval, and emitted heat.

10.-20. (canceled)
